(19) United States
(12) Patent Application Publication
(10) Pub. No.: US 2020/0342751 A1
(43) Pub. Date: Oct. 29, 2020

(54) Roadside Assistance System and Method

(71) Applicant: Roxroy Taylor, Brooklyn, NY (US)

(72) Inventor: Roxroy Taylor, Brooklyn, NY (US)

(21) Appl. No.: 16/858,270

(22) Filed: Apr. 24, 2020

Related U.S. Application Data
(60) Provisional application No. 62/837,796, filed on Apr. 24, 2019.

(51) Int. Cl. G08G 1/09; G01C 21/36; G01C 21/34; G01S 19/42

(52) U.S. Cl. CPC G08G 1/091; G01C 21/3691; G01S 19/421; G01C 21/3407; G01C 21/3667

(57) ABSTRACT

A roadside assistance system and method. The system includes a user device and a plurality of provider devices, each including a display, an input mechanism, a GPS module, a wireless transceiver, a processor, a non-transitory computer readable medium operatively connected to the processor, and a logic stored in the non-transitory computer readable medium that, when executed by the processor, causes the system to perform a method. The method includes receiving information relating to current traffic conditions from a remote database, calculating an optimal service provider based on service provider locations, work status, and current traffic conditions, and displaying an estimated arrival time based on current traffic conditions. The system allows users to quickly and easily request roadside assistance with the assurance of an accurate arrival time.

### CROSS REFERENCE TO RELATED APPLICATIONS

This application claims the benefit of U.S. Provisional Application No. 62/837,796 filed on Apr. 24, 2019. The above identified patent application is herein incorporated by reference in its entirety to provide continuity of disclosure.

### BACKGROUND OF THE INVENTION

The present invention relates to a roadside assistance system and method. More specifically, the present invention provides a roadside assistance system and method that utilizes traffic information and roadside assistance provider location information in order to calculate and request a particular service provider for a user.

When an individual has car troubles or experiences a breakdown that leaves them stranded on the side of the road, it is important to quickly assess the issue and get the vehicle and passengers to safety. To accomplish this, individuals often attempt to contact roadside assistance service providers for their services. When dealing with the stress of a roadside breakdown, it can be difficult to coordinate and contact the proper roadside assistance services for the current situation. Additionally, it is often not possible to choose an ideal service provider to quickly resolve the problem. Service providers are often currently engaged with work or have other work lined up, and it is difficult for individuals who need immediate emergency service to choose a specific provider without knowledge of timeframes. Roadside assistance service providers may be able to provide an estimate, but it is often a large window of time, and the service providers have no way of accurately estimating their arrival time based on external factors like traffic conditions.

Presently, there is no way for tow truck companies to pinpoint the exact location of drivers in need of assistance. In addition, drivers do not have an effective method for locating nearby roadside assistance companies when they are in an accident. After a collision, it takes time to clear the road, which can affect traffic and other drivers. Therefore, a software application for a mobile device that can both monitor current traffic conditions due to accidents and easily locate nearby roadside assistance vehicles while further directing the assistance vehicles to an accident scene is needed.

Systems and methods have been disclosed in the known art that relate to emergency roadside services. However, the systems and methods in the known art have several drawbacks. For example, many of these systems are restricted to a particular company or provider and do not provide the user with enough information to make an informed decision based on their current needs. Additionally, these systems may connect users with service providers but do not take into account the current traffic levels or other issues that would affect the timing of the service provider's arrival.

In light of the systems and methods disclosed in the known art, it is submitted that the present invention substantially diverges in functional and structural elements from the known art, and consequently it is clear that there is a need in the art for an improvement to roadside assistance systems and methods. In this regard the present invention substantially fulfills these needs.

### SUMMARY OF THE INVENTION

In view of the foregoing disadvantages inherent in the known types of roadside assistance systems and methods now present in the known art, the present invention provides a roadside assistance system and method wherein the same can be utilized for providing convenience for the user when requesting emergency roadside assistance services.

In one embodiment, the system includes a user device and a plurality of provider devices, each including a display, an input mechanism, a GPS module, a wireless transceiver, a processor, a non-transitory computer readable medium operatively connected to the processor, and a logic stored in the non-transitory computer readable medium that, when executed by the processor, causes the system to perform a method. The method includes the steps of the provider device and the user device receiving current traffic information and current provider device locations from a networked database and from provider device GPS modules, respectively; the user device displaying provider device locations and current traffic information; the user device calculating a chosen provider device based upon the provider device locations and current traffic information; the provider device receiving a service request from a user device; the provider device calculating an estimated response time based on current location and traffic information; and the user device receiving and displaying the estimated response time.

One object of the present invention is to provide roadside assistance to a stranded user as quickly as possible for safety purposes.

Another object of the present invention is to connect individuals with the proper roadside assistance service providers for a particular task based on the individual's current needs and location.

A further object of the present invention is to choose roadside assistance providers based on parameters like current traffic levels and current provider workload.

Yet another object of the present invention is to provide updated service provider arrival times to individuals based upon changing traffic levels.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a schematic diagram of an embodiment of the roadside assistance system and method.

FIG. 2 shows a top plan view of a display screen and graphical user interface of an embodiment of the roadside assistance system and method.

FIG. 3 shows a top plan view of an alternative display screen and graphical user interface of an embodiment of the roadside assistance system and method.

### DETAILED DESCRIPTION OF THE INVENTION

Reference is made herein to the attached drawings. Like reference numerals are used throughout the drawings to depict like or similar elements of the roadside assistance system and method. For the purposes of presenting a brief and clear description of the present invention, the preferred embodiment will be discussed as used for coordinating roadside assistance services between customers and providers. The figures are intended for representative purposes only and should not be considered to be limiting in any respect.

According to some embodiments, the operations, techniques, and/or components described herein can be implemented as (i) a special-purpose computing device having specialized hardware and a logic hardwired into the computing device to persistently perform the disclosed operations and/or techniques or (ii) a logic that is implementable on an electronic device having a hardware processor to execute the logic and a computer-readable medium, e.g. a memory, wherein implementation of the logic by the processor on the electronic device provides the electronic device with the function of a special-purpose computing device.

In the interests of economy, the present disclosure refers to “a computer-readable medium,” “a processor,” and so on. However, this should not be read as limiting in any way as the present disclosure contemplates embodiments of the present invention utilizing “one or more computer-readable media,” “one or more processors,” and so on. Unless specifically limited to a single unit, “a” is intended to be equivalent to “one or more” throughout the present disclosure.

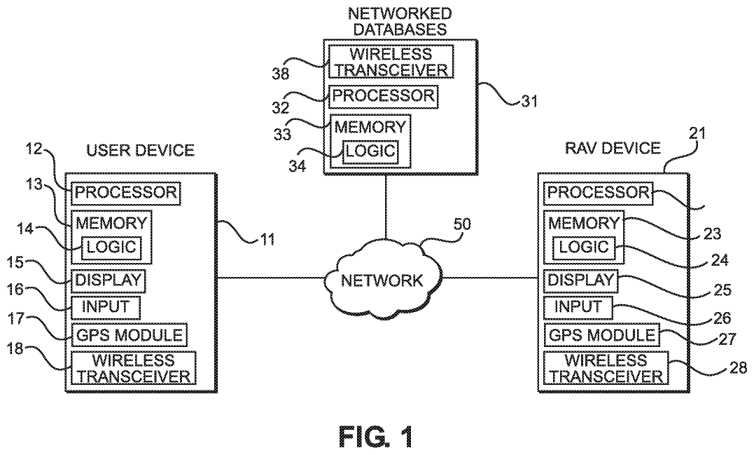

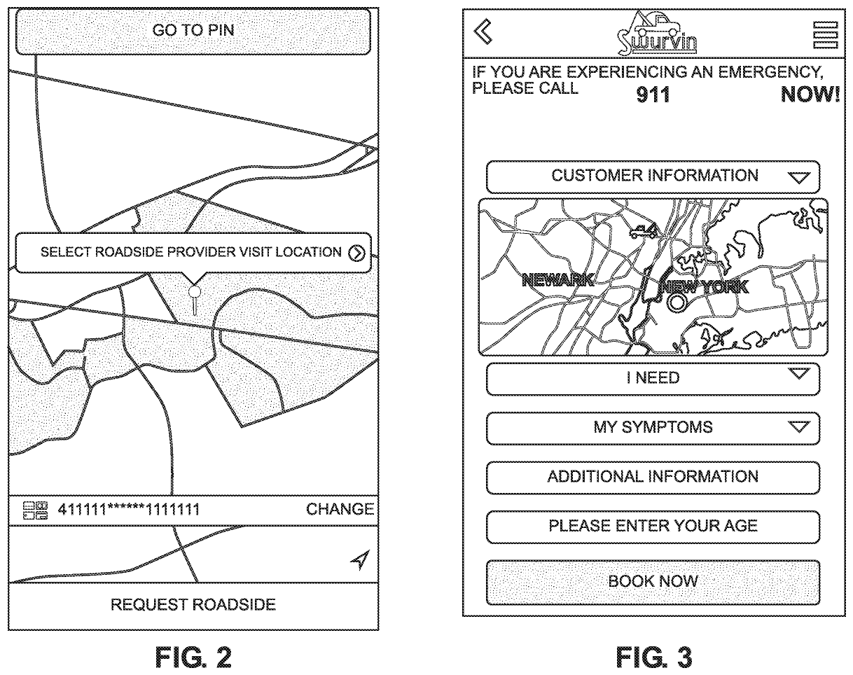

Referring now to FIG. 1, there is shown a schematic diagram of an embodiment of the roadside assistance system and method. The system generally includes at least one user device 12 and a plurality of Roadside Assistance Vehicle (hereinafter “RAV”) devices 21 in communication via a wireless network 50, such as the internet. The user and RAV devices 12, 21 include processors 12, 22, a memory 13, 23, a logic 14,24 stored on the memory 13, 23, a display 15, 25, an input mechanism 16, 26, a GPS module 17, 27. The displays 15, 25 can include a graphical user interface, examples of which are shown in FIGS. 2 and 3. The input mechanism 16, 26 can include touchscreens or any other suitable input mechanism such as buttons, keypads, or the like. The GPS modules 17, 27 are configured to determine the geographic locations of the user devices 11 and the provider devices 21. The location information is utilized when requesting services and when calculating arrival times.

The user and RAV devices 12, 21 further include wireless transceivers 18, 28 that facilitate wireless communication over the network 50. Additionally, the system includes one or more networked databases 31 including their own processors 32, memory 33, and logic 34, as well as wireless transceivers 38. The networked databases 31 calculate or receive calculated information relating to various parameters utilized to match customers with service providers and provide information regarding those parameters to the user. For example, the networked databases 31 may include real-time updated traffic levels for a particular area, updated geographic locations of multiple RAV devices 21, records of licenses and services for different RAV service providers, and profiles of multiple user devices 11. The user devices 12, RAV devices 21, and networked databases 31 are all in wireless communication with each other via the network 50 to facilitate near-instant exchange and calculating of information.

The logic 14, 24 stored on the user and RAV devices 12, 21 coordinate a method. The method includes the steps of the RAV provider device 21 and the user device 12 receiving current traffic information and current RAV device 21 locations from a networked database 31 and from provider device 21 GPS modules 27, respectively. The RAV device 21 can also receive the current location of the user device 12 so that the RAV provider can easily navigate to the user's location. The user device 12 displays current RAV device 21 locations and current traffic information overlaid on a map. The current traffic information received from the networked databases 31 can also be used in the logic 14 of the user device 12 to calculate an ideal RAV service for the user and provide updated arrival times. The traffic information can also be utilized to display an optimal route of travel on the display 25 of the RAV device 21 in order to quickly and safely navigate them to the user device 12 location. The user device logic 14 can calculate a chosen RAV provider device 21 based upon the RAV provider device 21 locations and current traffic information.

In operation, the RAV device 21 receives a service request from a user device 12. The provider device 21 calculates an estimated response time based on current location and traffic information received from the remote databases 31. The user device 11 receives and displays the estimated response time for the benefit of the user. The system can further provide the user device 11 with updated and current locations of RAV devices 21 within a particular geographic area on a map display, allowing the user to select an RAV provider that is closer to them.

Referring now to FIG. 2, there is shown a top plan view of a display screen and graphical user interface of an embodiment of the roadside assistance system and method. The display 15 of the user device 11 can include a map display that allows users to observe and transmit their current geographical location. The display 15 can also include payment prompts such that the user can quickly and easily pay for the required services. The map can also display the current location of nearby service providers to assist in the user's selection.

Referring now to FIG. 3, there is shown a top plan view of an alternative display screen and graphical user interface of an embodiment of the roadside assistance system and method. The display 15 of the user device 11 can also prompt the user for inputs regarding services needed, such that the needs are accurately communicated to the RAV devices 21. Additionally, the system can include an emergency operation mode that prompts the user for information such as symptoms, current emergency information, and the like. The logic 14 can determine the severity of the emergency and automatically contact an appropriate emergency response service such as the police or emergency medical services. When a service is selected and on the way to the user, the display 15 updates the map to show traffic conditions and estimated arrival times. In this way, the user has peace of mind and accurate information while waiting for the appropriate RAV service to arrive. The RAV service arrives quicker than normal because of the instant communication between devices and the optimal route guidance based on traffic. Further, the situation is able to be quickly and safely remedied due to the proper RAV being chosen depending on the needs of the user.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A roadside assistance system comprising:
a user device and a provider device, wherein each device comprises:
a display;
an input mechanism;
a GPS module;
a wireless transceiver;
a non-transitory computer readable medium operatively connected to the processor;
a logic stored in the non-transitory computer readable medium that, when executed by the processor, causes the system to perform a method, the method comprising:
the provider device and the user device receiving current traffic information and current provider device locations from a networked database and from provider device GPS modules, respectively;
the user device displaying provider device locations and current traffic information;
the user device calculating a chosen provider device based upon the provider device locations and current traffic information;
the provider device receiving a service request from a user device;
the provider device calculating an estimated response time based on current location and traffic information;
the user device receiving and displaying the estimated response time.

2) The roadside assistance system of claim 1, wherein the method performed by the system further comprises the provider device receiving the current location of the user device.

3) The roadside assistance system of claim 1, wherein the method performed by the system further comprises the user device displaying an emergency input prompt and automatically contacting an appropriate emergency service in response to a particular emergency input.

4) The roadside assistance system of claim 1, wherein the method performed by the system further comprises the user device or the provider device displaying an optimal route of travel calculated based upon current traffic conditions received from the networked database.

5) The roadside assistance system of claim 1, wherein the method performed by the system further comprises the user device receiving service information from a plurality of provider devices.

6) The roadside assistance system of claim 5, wherein the method performed by the system further comprises the user device calculating an optimal provider device based upon current provider device locations and the service information received from the plurality of provider devices.

7) A roadside assistance method comprising:
a provider device and a user device receiving current traffic information and current provider device locations from a networked database and from provider device GPS modules, respectively;
the user device displaying provider device locations and current traffic information;
the user device calculating a chosen provider device based upon the provider device locations and current traffic information;
the provider device receiving a service request from a user device;
the provider device calculating an estimated response time based on current location and traffic information;
the user device receiving and displaying the estimated response time.

8) The roadside assistance system of claim 7, wherein the method performed by the system further comprises the provider device receiving the current location of the user device.

9) The roadside assistance method of claim 7, further comprising the user device displaying an emergency input prompt and automatically contacting an appropriate emergency service in response to a particular emergency input.

10) The roadside assistance method of claim 7, further comprising the user device displaying an optimal route of travel calculated based upon current traffic conditions received from the networked database.

11) The roadside assistance method of claim 7, further comprising the user device receiving service information from a plurality of provider devices.

12) The roadside assistance method of claim 11, further comprising the user device calculating an optimal provider device based upon current provider device locations and the service information received from the plurality of provider devices.
